(19) United States
(12) Patent Application Publication
(10) Pub. No.: US 2017/0106329 A1
(43) Pub. Date: Apr. 20, 2017

(54) Method and Device for Identifying Faults in a Pneumatic System

(71) Applicant: KNORR-BREMSE Systeme fuer Nutzfahrzeuge GmbH, Muenchen (DE)

(72) Inventors: Zoltan BORDACS, Veszprem (HU); Gabor VIG, Budapest (HU)

(21) Appl. No.: 15/394,905

(22) Filed: Dec. 30, 2016

Related U.S. Application Data
(63) Continuation of application No. PCT/EP2015/065111, filed on Jul. 2, 2015.

(30) Foreign Application Priority Data
Jul. 4, 2014 (DE) 10 2014 009 991.1

(51) Int. Cl. B01D 53/04; B60T 17/22; B01D 53/26; B60T 17/00

(52) U.S. Cl. CPC B01D 53/0454; B60T 17/004; B60T 17/221; B01D 53/261; B01D 2257/80; B01D 2259/4566

(57) ABSTRACT

A method and device are provided for identifying at least one fault in a regeneration path of a pneumatic system in a motor vehicle. The method, in which air is conducted from a regeneration air reservoir through a drying cartridge in order to regenerate the drying cartridge, is characterized in that at least one physical parameter of the air is acquired in a component of the regeneration path, the at least one physical parameter is analyzed by a calculation unit in order for a fault to be identified, and the result of the analysis is further processed.

### CROSS REFERENCE TO RELATED APPLICATIONS

This application is a continuation of PCT International Application No. PCT/EP2015/065111, filed Jul. 2, 2015, which claims priority under 35 U.S.C. §119 from German Patent Application No. 10 2014 009 991.1, filed Jul. 4, 2014, the entire disclosures of which are herein expressly incorporated by reference.

### BACKGROUND AND SUMMARY OF THE INVENTION

The present invention relates to a method for detecting at least one fault in a regeneration path of a compressed-air system of a motor vehicle, wherein, to regenerate an air drying cartridge, air is passed through the air drying cartridge from a regeneration-air reservoir. Furthermore, the invention relates to a device for carrying out this method.

The term regeneration is to be understood as meaning the operating state in which a wet drying cartridge is dried by a stream of drying air. The regeneration-air reservoir is a compressed-air reservoir from which dry air can be removed for the purpose of flowing through the drying cartridge via a regeneration path, in the opposite direction to the standard direction of air flow during operation, while the regeneration is taking place.

The field of application of the invention encompasses commercial vehicles which have compressors. The air provided by such compressors may contain liquid in the form of vapors or aerosol particles which are passed to elements, such as for example valves or shock-absorbing means or air ducts, which are not designed for contact with humid air and may thus be damaged.

Therefore, in order to dry the compressed air, the generally known prior art uses drying means, such as drying cartridges, which are filled with a material (desiccant) that is able to take up liquid. If a compressed-air stream containing liquid is passed through a material of this type inside a drying cartridge, its liquid components are effectively removed. As a result, however, the drying cartridge will in exchange fill up with liquid until a saturation point is reached, beyond which the drying cartridge cannot sufficiently take up liquid, if at all, and as a result loses its filter action. To counteract this state, a regeneration is carried out, consisting in drying air being passed through the wet drying cartridge, generally from the opposite direction to the compressed-air flow direction provided in normal operation, for example using dry compressed air from a regeneration reservoir, in order to take up and/or carry away the moisture of the material in the drying cartridge.

In this process, the effectiveness of the regeneration and/or its drying capacity may be adversely affected along the entire flow path, on account of faults (defects) such as for example clogging, icing, pinching or wear.

The object of the present invention is to provide a method and a device which check the regeneration path for faults. A further object of the invention is, if appropriate, to provide a solution which counteracts the effects of the respective defects on the regeneration.

This and other objects are achieved in accordance with the invention by a method, and a corresponding device, for detecting at least one fault in a regeneration path of a compressed-air system of a motor vehicle. To regenerate a drying cartridge, air is passed through the drying cartridge from a regeneration-air reservoir. At least one physical variable of the air in a component of the regeneration path is recorded. The at least one physical variable is analyzed by a calculation unit for fault detection, and the result of the analysis is further processed.

The invention encompasses the technical teaching that at least one physical variable of the air in a component of the regeneration path is recorded, and the at least one physical variable is analyzed by a calculation unit for defect detection, and the result of the analysis is processed further.

Preferably, the physical variable is recorded in the regeneration-air reservoir. An advantage of this solution is that a sensor is provided which, during the regeneration, monitors at least one physical variable of the compressed air in an element of the compressed-air system, preferably the regeneration-air reservoir, and transmits the measured value thereof to a signal processing algorithm, which is executed on the calculation unit and can be used, for example, to diagnose the occurrence and disappearance of a fault.

According to an advantageous embodiment of the invention, the at least one physical variable is obtained by direct measurement or by measurement of other physical variables and subsequent calculation or estimation or by electronic transmission. The first alternative allows reliable and fast recording of the physical variable of interest, while the second alternative makes it possible, if appropriate, to dispense with complex measurement methods, such as additional sensor equipment. For example, it may be possible, by measuring the pressure, to make statements regarding the temperature of compressed air stored in a known volume.

According to one measure which improves the invention, it is proposed to configure the algorithm in such a way that the latter determines the nature of the fault. It is in this way possible to select a targeted strategy, for example to compensate for or avoid this fault.

Furthermore, the invention is enhanced if the algorithm is configured in such a way that it quantifies the influence of the fault. This may, for example, be the flow density of compressed air which emerges at a leak or the flow resistance caused by a clogged or frozen valve or the drying cartridge. By quantization of this nature, it is possible to further optimize the choice for example of the compensating or bypassing regeneration strategy.

An advantageous configuration of the invention provides for the result which is achieved by the algorithm to be output, for example in the form of an electronic or visual transmission, or to be stored, for example on an electronic data carrier. It is thus possible for the results of the algorithm to be further processed or checked by independent external systems or human users.

According to an advantageous refinement of the invention, the regeneration of the drying cartridge is adapted to the results of the algorithm diagnosing the fault. In this way, it is possible to restore the functionality of the drying cartridge even if a fault is present in the compressed-air system, provided that this fault can for example be bypassed or compensated by a strategy used in the regeneration.

A particularly advantageous configuration of the invention provides for the algorithm to analyze the effectiveness of the regeneration of the drying cartridge. This can be achieved for example by use of a sensor that measures the liquid content in the drying cartridge, and then evaluating the measurement data. It is in this way possible to ensure or at least check the effectiveness of the drying cartridge.

According to a preferred configuration of the invention, the fault that can be detected by the algorithm belongs to a group of faults comprising clogging, icing, pinching, leaking, blockage by foreign bodies or closure of a line, a valve, an air-outlet duct, a sound absorber or a drying cartridge. These are defects which may occur in practice and can disrupt or prevent the regeneration.

In particular, the valve may belong to a group of valves comprising solenoid valves, non-return valves and outlet valves. These are the main valve forms of a compressed-air system dealt with by the invention.

A particularly noteworthy, advantageous embodiment of the invention provides for the physical variable to belong to a group of physical variables comprising temperature, flow rate, density, pressure, flow velocity, mass and energy. By means of a suitable algorithm, these physical variables of the compressed air make it possible to make statements regarding the abovementioned relevant faults.

Furthermore, the present invention is improved if at least one parameter that is specific to the commercial vehicle is taken into account in the algorithm. These may be, for example, the volume of air reservoirs provided in or at the compressed-air system, braking chamber configurations, the values of constant air consumption in operation or other parameters relating in particular to the compressed-air system. It is in this way possible to adapt the algorithm to different vehicle types in order, for example, to improve the reliability or accuracy of the analysis according to specific vehicle types.

Furthermore, an improvement of the invention provides for not only the occurrence but also, by means of a so-called reversible algorithm, the disappearance of a fault to be detected, whereupon suitable measures can be taken for the regeneration.

A further improvement to the invention is achieved if the algorithm is modified by parameters, in particular in automated fashion or by a user. In this way, the manner in which the algorithm functions can be adapted without the algorithm having to be changed or its source code reprogrammed.

Furthermore, the invention is improved if data from other systems which monitor or use sensors to record the compressed-air system are also taken into consideration in the analysis by the calculation unit. This applies for example to systems which test or monitor the compressed-air system for leaks.

Other objects, advantages and novel features of the present invention will become apparent from the following detailed description of one or more preferred embodiments when considered in conjunction with the accompanying drawing.

### BRIEF DESCRIPTION OF THE DRAWING

The Figure shows a schematic flow diagram of an example of a compressed-air system according to the invention in which an exemplary method is carried out.

Device components are illustrated by rectangles, data by circles, air-flow connections by solid lines, directional data connections by dashed arrows and air-flow directions by solid arrows.

### DETAILED DESCRIPTION OF THE DRAWING

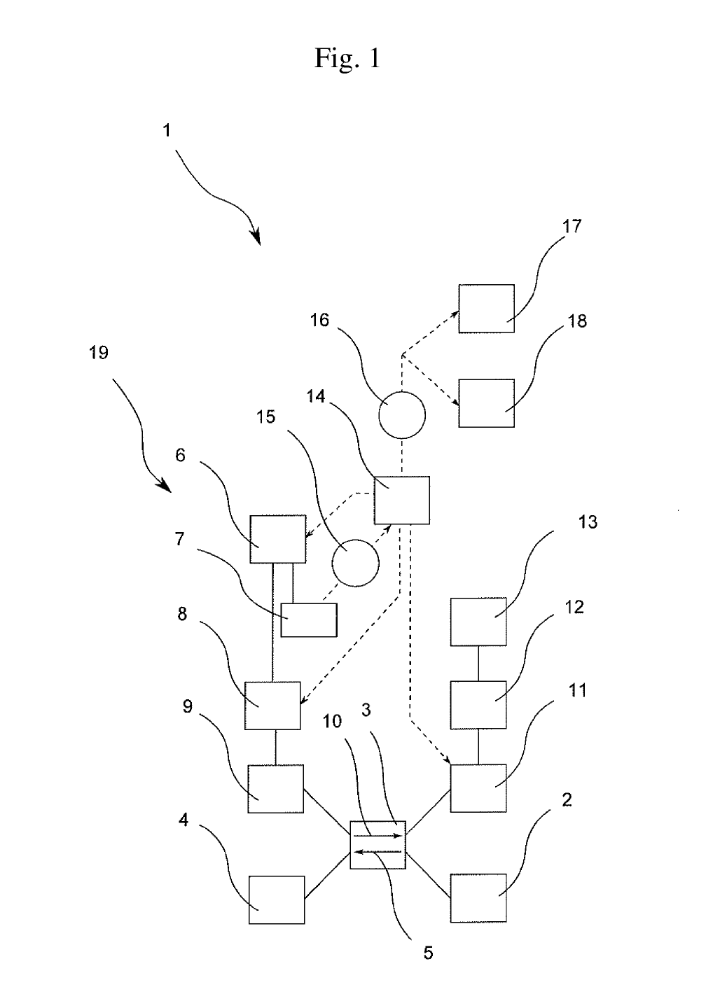

As shown in FIG. 1, inside a compressed-air system 1 of a motor vehicle (not shown further), the output side of a compressor system 2 is connected to a drying cartridge 3, which in turn is connected to a consumer system 4.

In the operating state, the compressor system 2 pumps air, which may be humid, in an operating direction 5 through the drying cartridge 3, where this air is dried until the drying cartridge 3 becomes saturated, and then onwards into the consumer system 4.

In order to regenerate or dry the potentially saturated drying cartridge 3, in a regeneration mode dry air is passed from a regeneration-air reservoir 6, via a solenoid valve 8 and a non-return valve 9, into the drying cartridge 3. Then, dry air flows through the drying cartridge 3, in a regeneration direction 10 that is opposite to the operating direction 5, with the result that the regeneration or drying of the drying cartridge is carried out. This air stream is then released to the environment via an outlet valve 11 and an outlet duct 12 as well as a sound absorber 13. The abovementioned components between regeneration-air reservoir 6 and sound absorber 13, inclusive, form the regeneration path 19.

If a fault, for example clogging of an air line (not shown) or jamming of the solenoid valve 8, of the non-return valve 9 or of the outlet valve 11, or freezing of the drying cartridge 3, or other mechanical problems or other, for example wear-related malfunctions of a component in the regeneration path 19, occurs, then for example the flow resistance of the regeneration path 19 changes as a result.

According to the invention, a sensor 7, in the present example a pressure sensor 7, measures a physical variable of the regeneration path 19, in this example the pressure in the regeneration-air reservoir 6. The changed flow resistance results in a change in the temporal curve of the pressure measured by the pressure sensor 7. For example, it may drop more slowly than usual when the solenoid valve 8 is blocked.

The pressure sensor 7 is electronically connected to a calculation unit 14. The physical variable 15, measured by sensor-based recording of the pressure sensor 7, is transferred to an algorithm which is executed on the calculation unit 14 and, taking account of programmed-in information about vehicle-specific parameters of the compressed-air system 1, analyzes the fault, i.e. establishes and quantifies its location, i.e. the component affected, and its nature, for example the flow resistance of a blockage.

The result 16 of the analysis is in parallel processed further by being displayed on an output module 17 in the form of a monitor and by being stored on a storage module 18 for later evaluation. Moreover, the calculation unit actuates for example an electronically controllable compressed-air supply of the regeneration-air reservoir 6, the solenoid valve 8 or the outlet valve 11 in order to adapt the regeneration to the fault.

The invention is not restricted to the preferred exemplary embodiment described above. Variations are also contemplated and are covered by the scope of protection of the claims which follow.

For example, rather than or in addition to measuring the physical variable pressure, it is also possible to measure for example the temperature or the flow density of air in a component or between two components of the regeneration path. The method according to the invention is in particular also applicable if, during regeneration, no pressure drop is measureable in the regeneration-air reservoir. Also, the fault and the indicator indicating the fault may be altogether different, for example a drop in density caused by a leak.

### LIST OF DESIGNATIONS

1 Compressed-air system

2 Compressor system

3 Drying cartridge

4 Consumer system

5 Operating direction

6 Regeneration-air reservoir

7 Sensor

8 Solenoid valve

9 Non-return valve

10 Regeneration direction

11 Outlet valve

12 Outlet duct

13 Sound absorber

14 Calculation unit

15 Physical variable

16 Result

17 Output module

18 Storage module

19 Regeneration path

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for detecting at least one fault in a regeneration path of a compressedair system of a motor vehicle, the method comprising the acts of:
regenerating a drying cartridge via air passed through the drying cartridge from a regeneration-air reservoir;
recording at least one physical variable of the air in a component of the regeneration path;
analyzing the at least one physical variable, via a calculation unit, for fault detection; and
further processing the result of the analyzing of the at least one physical variable for the fault detection.

2. The method according to claim 1, wherein
the at least one physical variable is obtained by direct recording by a sensor.

3. The method according to claim 1, wherein
the at least one physical variable is obtained by recording another physical variable by a sensor and performing a subsequent calculation or estimation to obtain the at least one physical variable.

4. The method according to claim 1, wherein the at least one physical variable is obtained by an electronic transmission.

5. The method according to claim 2, wherein the sensor records the at least one physical variable in the regeneration-air reservoir.

6. The method according to claim 1, wherein the calculation unit identifies a nature of the fault.

7. The method according to claim 1, wherein the calculation unit quantifies a quantifiable property of the fault.

8. The method according to claim 1, wherein the act of further processing comprises outputting the result of the analysis to an output module or storing the result of the analysis on a storage module.

9. The method according to claim 1, wherein the act of further processing comprises adapting the regenerating of the drying cartridge based on a control of the calculation unit as a function of the result of the analysis.

10. The method according to claim 1, wherein the calculation unit analyzes an effectiveness of the regenerating of the drying cartridge.

11. The method according to claim 6, wherein the nature of the defect identifiable by the calculation unit is one of:
clogging, icing, pinching, blockage by foreign bodies or closure of a line, a valve, an outlet duct, a sound absorber or a drying cartridge.

12. The method according to claim 11, wherein the valve is one of a solenoid valve, a non-return valve or an outlet valve.

13. The method according to claim 1, wherein the physical variable is one of temperature, flow rate, density, pressure, flow velocity, mass, or energy.

14. The method according to claim 1, wherein the calculation unit factors into account at least one parameter specific to a commercial vehicle.

15. The method according to claim 1, wherein the calculation unit detects a disappearance of a fault.

16. The method according to claim 1, wherein an algorithm executed on the calculation unit is modified by parameters.

17. The method according to claim 1, wherein the calculation unit uses information from other systems interacting with the compressed-air system, including a leak monitoring system, in order to improve accuracy of the analysis.

18. A device for detecting at least one fault in a compressed-air system of a motor vehicle having a drying cartridge for drying compressed air, the device comprising a calculation unit having a processor that executes instructions to:
receive at least one physical variable of air in a component of a regeneration path for the drying cartridge, and
analyze the at least one physical variable for fault detection.
